(19) United States
(12) Patent Application Publication
(10) Pub. No.: US 2025/0243094 A1
(43) Pub. Date: Jul. 31, 2025

(54) METHOD AND SYSTEM FOR METHANE REDUCTION IN WATER BODIES

(71) Applicants: Colin Davis, Manotick (CA); David Tat Fai Fung, West Vancouver (CA); Neil Teitelbaum, Ottawa (CA)

(72) Inventors: Colin Davis, Manotick (CA); David Tat Fai Fung, West Vancouver (CA); Neil Teitelbaum, Ottawa (CA)

(21) Appl. No.: 19/038,839

(22) Filed: Jan. 28, 2025

(30) Foreign Application Priority Data
Jan. 30, 2024 (CA) 3227755

(51) Int. Cl. C02F 7/00; C02F 103/00

(52) U.S. Cl. CPC C02F 7/00; C02F 2103/007; C02F 2201/009; C02F 2201/483

(57) ABSTRACT

A method and system for lessening an amount of methane released into the atmosphere from of a body of water uses an electronic device having an at least partially submerged transducer which provides a signal that enhances oxygenation with a water moving device such as a centrifugal RFWSS to move at least some of the water at a first range of depths within a first density range with at least some of the water at a second lower range of depths within a second density range to lessen a stratification within the body of water wherein the average density in the first density range is different than the average density in the second density range. The use of the two results in an unexpected synergy and promotes oxygenation of the lower layers, thereby lessening an amount methane that would otherwise be released into the atmosphere.

### CROSS-REFERENCE TO RELATED APPLICATIONS

The present invention claims priority from Canadian Patent Application No. 3,227,755 filed Jan. 30, 2024, which is incorporated herein by reference.

### FIELD

This disclosure relates to a method and system for reducing methane in of water in a body of water.

### BACKGROUND

Oceans, lakes and ponds provide essential resources for a wide range of species of terrestrial and organic organisms, and such water bodies require oxygen-enriched water to support life. The structure and function of ponds and lakes are determined by factors such as turbulence, temperature, and water depth. Wind turbulence and temperature interact to influence stratification and water circulation within lakes and ponds.

At certain times of the year, for instance in the spring, wind turbulence circulates the water throughout a lake supplying oxygen to the entire water column throughout its depth. Notwithstanding, as the temperature increases during the summer and wind subsides, thermal stratification occurs, producing distinct layers in the water column; the upper warm-water layer is separated from the lower cold-water layer by a thermocline. A thermocline is a distinct layer in a large body of water, such as an ocean or a lake, where the temperature changes rapidly with depth. In most cases, the temperature decreases with increasing depth in the ocean. The thermocline separates the warmer, well-mixed surface layer (epipelagic zone) from the colder deep water below (mesopelagic and bathypelagic zones). The thermocline is important because it acts as a barrier to mass transfer and convective heat transfer between the surface and deep layers of the ocean. This stratification has significant implications for marine life, ocean circulation, and weather patterns.

A halocline is a layer in a large body of water characterized by a rapid change in salinity with depth. Salinity refers to the concentration of dissolved salts in water. In oceans, the surface layer has relatively lower salinity due to freshwater inputs from rivers, melting ice, and precipitation. As one goes deeper into the ocean, the salinity usually increases. A halocline separates the less saline surface water from the more saline deep water. Like the thermocline, the halocline also affects ocean circulation and can create barriers to the vertical mixing of water masses.

Temperature and salinity are the two primary factors that influence the density of seawater. Cold water is denser than warm water, and water with higher salinity is denser than water with lower salinity. The combination of these two factors results in different water masses with varying densities. The thermocline and halocline influence the density of water in their respective layers. Density variations play a crucial role in ocean circulation and vertical mixing. In some regions, the thermocline and halocline can interact, affecting the overall water column's stratification and circulation patterns. In summary, thermoclines and haloclines are both transition zones in the ocean and coastal water, defining changes in temperature and salinity, respectively. These transitions have significant effects on density and can impact various oceanic processes and ecosystems.

Oxygen concentration of the water in the lower layer tends to decline compared to the upper layer as a result of a lack of water circulation. Without mixing to replenish dissolved oxygen, respiration by organisms within the lower layer may further reduce oxygen concentrations.

In aquaculture, heavy-oxygen-enriched water is required; as a result, oxygenating machines have been used to disturb the surface of the water and facilitate oxygenation. Some of these machines are more energy efficient than others. These machines include aerators, bubblers and agitators and within these three classes of devices or machines there are many tens of sub-types. What most of these machines have in common is the consumption of significant power to run them. There are other drawbacks as well; for example, water wheels and other machines that launch water into the air to oxygenate increase evaporation of the water that they are oxygenating. Furthermore, they primarily affect water near the surface. Acrator and agitator type devices described in U.S. Pat. No. 6,155,794 in the name of Shihai Wu. High Speed aerators are disclosed in CN application Ser. No. 21/942,1936 in the name of Xiaomeng et al where the aerator impeller turns at thousands of RPMs per second. Another high speed acrator is disclosed in CN application Ser. No. 21/873,6691 in the name of Chen Shuyou and Chinese Patent in the name of Jian CN20098805 describe devices that rotate at very high speeds, for example 900-1800 RPMs and consume considerable power.

Another type of device which is not per-say and an aerator or an agitator, and which may be powered with solar panels, using minimal power, is a radial flow water surface spreader (RFWSS). A radial flow water surface spreader, sometimes referred to a as a biofan, comprises of a floating mechanical device which imparts a horizontal radial force on the water surface with preferably minimal or no vertical force components to conserve the energy required to achieve the maximum range of impact on the water surface. Consequently, it is preferable that this device does not impart any vertical force vectors or local component mixing, i.e., its primary function is not that of water mixer or a mechanical acrator. Its primary function is that of a water mover. The radial flow water surface spreader generates a radial bulk circulation of the affected waterbody without any significant local component mixing. Although the RFWSS performs oxygenation well during daylight hours, its success, commercially, has been very limited and in fact many of these RFWSS devices are today considered functionally inadequate and many are no longer being used. By using an RFWSS a significant drawback occurs when the sun is not present, for example during the night. The way in which the RFWSS works is that as its paddles gently rotate at a very slow speed and move the surface water around the device. The radial outward flow of the surface water generates a water “conveyor belt” with minimum local mixing. This water conveyor belt loops back to the lower water layer because of the hydraulic suction created by the upward movement of the water immediately underneath of the RFWSS to fill the gap left by the outward moving water surface layer. Conveniently thermoclines are diminished and consequently, the phytoplankton and the hypoxic water at the lower depths of the waterbody are brought up to the surface. The exposure to the solar radiation at the surface permits these phytoplankton to grow through photosynthesis which releases oxygen into the water. As a water mover, the RFWSS is a poor mechanical aerator which depends on high turbulence generated by high-speed rotating blades to produce large areas of water/air interface to achieve its high rate of oxygenation. The RFWSS achieves water oxygenation differently, through the oxygen released in the photosynthesis process. This circulation which is primarily via moving rather than mixing permits more phytoplankton to grow (biological productivity) throughout the whole waterbody within this water circulation loop. However, this higher phytoplankton population stops generating oxygen at night when there is no photosynthesis and its respiration consumes more dissolved oxygen. Without an effective pathway to bring more oxygen from the air into the water, the waterbody, especially the lower depths, turns hypoxic at night and this is highly problematic.

An entirely different device is known, which effectively and with very low power increases the oxygenation of water bodies. U.S. Pat. Nos. 10,934,186, 10,875,794, 10,737,796 and 10,767,021 all in the name of xn et al., describe this device which promotes oxygenation of large bodies of water by using a suitably programmed signal generator coupled to a transducer which provides a signal which transmits a alternating magnetic field changing one or more physicochemical properties of water resulting in changes in the gas transfer rate across the water/air interface including but not limited to increases in gas absorption, for example oxygen by a body of water. This device hereafter will be referred to an alternating magnetic field generating device (AMFGD). Notwithstanding the aforementioned device's ability to increase the gas exchange rate of a water body with the atmosphere, we have noticed that it is much less effective at oxygenating lower layers within large bodies of water and it would be desirable to increase the efficacy in the oxygenation of the lower colder layers. The accelerated gas transfer rate catalyzed by the AMFGD rapidly saturates the water surface layer immediately next to the atmosphere with oxygen. Further transfer of oxygen from the atmosphere to the waterbody is limited by the rate of diffusion of the dissolved oxygen in water surface layer to the lower water layers or by the local bulk mixing of the water surface layer with the lower water layers. Although Parisien et al. suggest that oxygen or air may be added to the polar liquid before or concurrently with energizing the transducer in the form of bubbles or by mechanical agitation of the polar liquid, mechanical agitators used in combination with Parisien's AMFGD will not produce any highly unexpected result. Using the ultra-low power consuming AMFGD with a typical mechanical agitator or aerator which rotates at very high speed will add surprisingly small amounts of oxygen to the water body at a very high cost in terms of energy consumed, potential unwanted evaporation, noise pollution, and maintenance cost and actual output versus input. The high water turbulence and local mixing generated by mechanical aerators has been observed to have a deleterious impact on the accelerated oxygenation effectiveness of the AMFGD.

A significant environmental problem the world is faced with today is a result of methane emissions from water bodies. Aquatic ecosystems, including lakes, rivers, wetlands, and reservoirs, contribute substantially to global methane emissions. Methane is a potent greenhouse gas, with a global warming potential many times greater than carbon dioxide. Studies estimate that aquatic ecosystems may contribute between 41% to 53% of total methane emissions globally. The methane released from these water bodies is primarily produced by microorganisms in oxygen-free sediments through a process called methanogenesis. As methane rises through the water column, some of it is oxidized by other microorganisms, but a significant portion still reaches the atmosphere. This contributes to the greenhouse effect and exacerbates climate change.

Methane is released from deep water sediments or underwater sources. As methane rises through the water column, it encounters increasing levels of dissolved oxygen. Methane-oxidizing bacteria (methanotrophs) in the oxygenated layers use methane as an energy source. These bacteria convert methane (CH₄) into carbon dioxide (CO₂) and water (H₂O) through a series of biochemical reactions. In the atmosphere, hydroxyl radicals (OH) play a significant role in oxidizing methane. When methane reaches the oxygenated layers, it can also react with hydroxyl radicals, further reducing its concentration.

Oxygenating a water body offers significant environmental benefits, particularly in reducing methane and other greenhouse gases released into the atmosphere. By increasing the oxygen levels, microbial oxidation of methane is enhanced, converting it into less harmful carbon dioxide and water. This process helps mitigate the impact of methane, a potent greenhouse gas, on climate change. Expanding the upper oxygenated region of the water body ensures that more methane is exposed to oxygen, promoting its oxidation before it can escape into the atmosphere.

Methane oxidation is a biochemical process where methane-oxidizing bacteria (methanotrophs) convert methane (CH₄) into carbon dioxide (CO₂) and water (H₂O) in the presence of oxygen. This process is crucial in reducing methane emissions from water bodies. When methane rises from deep water levels to oxygenated layers, these bacteria utilize the available oxygen to oxidize methane, thereby reducing its concentration. Additionally, the presence of oxygen supports the growth and activity of these bacteria, enhancing the overall efficiency of methane oxidation. By expanding the oxygenated region, more methane can be intercepted and oxidized before it reaches the atmosphere, thus reducing the greenhouse gas emissions.

By expanding the oxygenated layer, more methane encounters oxygen as it rises through the water column. This increases the likelihood of methane being oxidized by methane-oxidizing bacteria (methanotrophs) before it reaches the surface. The additional oxygen supports the growth and activity of methanotrophs, which are crucial for converting methane into carbon dioxide and water. This enhanced microbial activity leads to more efficient methane oxidation. With a thicker oxygenated layer, methane has a longer contact time with oxygen, allowing for more complete oxidation. This reduces the amount of methane that escapes into the atmosphere.

The process of methane oxidation is driven by the availability of oxygen and the presence of methanotrophs. By increasing the oxygenated layer, you create a more favorable environment for these bacteria to thrive and perform their function. This results in a higher rate of methane oxidation, thereby reducing the amount of methane released into the atmosphere. Methane is a potent greenhouse gas, and its reduction can significantly mitigate climate change impacts.

In the process of adding oxygen, it is preferable to do so without a significant amount of turbulence. For example, high speed aerators are less than ideal. Strong turbulence can cause methane to rise to the surface faster. Turbulence increases the mixing and movement of water, which can accelerate the upward movement of methane bubbles. The key is to balance the level of turbulence to ensure effective oxygenation without causing methane to escape too quickly. A very moderate amount of turbulence can enhance the distribution of oxygen and promote microbial oxidation of methane without causing it to rise too rapidly. We have found that by using the combination of an AMFGD with a RFWSS provides sufficient mixing and oxygenation while minimizing the risk of methane escaping.

By combining the use of the RFWSS with the AMFGD, this disclosure addresses the issue related to the RFWSS's inadequacy due to anoxia which occurs at night and the issue related to the AMFGD's inability to avoid rapid saturation of the water surface layer or adequately reach and oxygenate water at lower depths and in doing so yields a synergistic result. The limitations of both devices are obviated by their use together. The use of both of these devices together significantly reduces the amount of methane released into the environment. In a preferred embodiment, the RFWSS is equipped with very low powered electric motor that moves it slowly across the water body in a random fashion.

In addition to this, as the AMFGD enables the water to absorb a greater amount of oxygen it also lessens the viscosity and surface tension of the water which in turn lessen the amount of energy required to turn the paddles of the RFWSS or extend the effective range of the RFWSS with the same amount of energy consumption, producing another synergistic result.

Although using the RFWSS produces deleterious hypoxia at night as described heretofore, we have discovered that using the AMFGD with the RFWSS together an accelerated oxygenation pathway is provided to minimize this hypoxia in the waterbody with the RFWSS functioning as a water conveyor belt continuing to present hypoxic water at the water surface layer to accelerate more oxygen transfer into the water under the influence of the Parisien et al. AMFGD. Another significant benefit of using these two devices together is that denser water residing at greater depths that would otherwise not have been affected by the AMFGD can be oxygenated as the water moving RFWSS brings that water to the surface. One more advantage of using the two devices together is that the AMFGD in operation, lessens the viscosity of the water requiring less power for the RFWSS to turn its blades, therefore saving energy, or extend the effective range of the RFWSS with a higher tip velocity of the slowly rotating paddles of the RFWSS. In this way another synergistic result is obtained. . . . Yet another benefit is that the transducer device is silent and the RFWSS is nearly silent in operation. This is a significant benefit as these devices are generally placed in natural habitats of many animals and disturbance would be minimal.

In one embodiment described herein, an RFWSS, with similar basic operation to the ones described in Chinese Utility Patent CN201678528U in the name of Zelin Tan and described in patent application CN102515375A in the names of Kebiao Sun et al., is used together with an AMFGD described by Parisien et al. in the U.S. Pat. No. 10,934,186 to produce a surprising synergistic result. The amount of oxygen absorbed in a waterbody using the RFWSS together with the AMFGD is significantly greater than the sum of the amount of oxygen absorbed using each device alone. The accelerated gas transfer rate in the presence of an activated AMFGD rapidly saturates the water surface layer with dissolved oxygen which must be transferred into the bulk water by diffusion before more oxygen can be transferred from the air into water surface layer. This diffusion step often becomes the rate limiting step in maximizing the oxygen flux from the air into the water. Without prompt removal of the dissolved oxygen from the water surface layer, the interfacial transfer rate of oxygen from the air into the water would decline as an exponential function of time. An RFWSS generates bulk moving of the water surface layer and circulates the anoxic water from the lower water layer into the water surface layer. The continual renewal of the water surface with anoxic water maximizes the driving force to transfer oxygen from the air into the anoxic water surface layer in the presence of an activated transducer.

In a hypoxic waterbody, the dissolved oxygen concentration of the water surface layer increases with the apparent interfacial mass transfer coefficient, Kn which is the difference between the actual interfacial mass transfer coefficient, Ka, less the convective liquid mass transfer coefficient, Kc, caused by the bulk liquid circulation generated by the RFWSS immediately under the water surface layer.

Kn=Ka−Kc

Since the total amount of oxygen transferred from the atmosphere into a hypoxic waterbody over a period of time is inversely proportional to the exponential function of Kn, depending on the actual field conditions, an RFWSS in combination with an AMFGD described herein may increase the amount of oxygen transferred into the waterbody over a period of time by 2-10 folds over those achieved by deploying the AMFGD alone.

The much higher dissolved oxygen concentration of the water column under the effect of the RFWSS and an activated transducer transmitting a signal of a suitable frequency and intensity generates a dissolved oxygen concentration gradient between the water column under the effect of an RFWSS and the surrounding water. The higher oxygen diffusivity in water in the presence of an activated AMFGD accentuates the effective range of the RFWSS in the lower layer of water in disrupting the anoxia under the thermocline.

The effective range of an RFWSS is determined by the tip velocity of the rotating paddle. The lower water viscosity in the presence of an activated transducer transmitting a signal of a suitable frequency and intensity permits a higher tip velocity of the rotating paddle of a RFWSS and extends its effective range.

The higher Reynolds Number in the radiating laminar flow of the water surface will increase the interfacial mass transfer coefficient which is further enhanced by the signal generated by the transducer described herein over a larger effective water surface area. Consequently, a RFWSS in combination with a transducer described herein may increase the amount of oxygen transferred from the atmosphere into a hypoxic waterbody by 3-5 folds over those achieved by deploying the RFWSS alone.

When a thermocline is disrupted by the water circulation generated by a RFWSS, a temperature gradient is formed between the water column under the effect of a RFWSS and the surrounding water. The higher water thermal conductivity in the presence of an activated transducer transmitting a signal of a suitable frequency and intensity accentuates the effective range of the RFWSS in disrupting the thermocline.

When a halocline is disrupted by the water circulation generated by a RFWSS, a salt concentration gradient is formed between the water column under the effect of a RFWSS and the surrounding water. The higher salt diffusivity in water in the presence of an activated transducer transmitting a signal of a suitable frequency and intensity accentuates the effective range of the RFWSS in disrupting the halocline.

In summary, the combination of a RFWSS with an activated transducer transmitting a signal of a suitable frequency and intensity can generate a much higher oxygen flux from the air into the water and extends the effective range of a RFWSS in oxygenation and disruption of a thermocline or halocline in a water body. This, in effect directly lessens an amount of methane released into the atmosphere, and achieves this using a very small amount of energy. The synergistic combination of the RFWSS and AMFG together produce this significant result which can to some extent remediate greenhouse gas related climate change.

### SUMMARY

A method of accelerating the oxygenation of a body of water and lessening an amount of methane released into the atmosphere by changing a property of water within the body of water comprising:
moving with a radial flow water surface spreader (RFWSS) having a plurality of paddles, at least some of the water at a second range of depths to a first range of depths; and,
transmitting an alternating signal with an electronic device having an energized first transducer to affect at least some of the moved water to change a property thereof, wherein the property is gas exchange rate.

In accordance with the disclosure there is provided, a method of accelerating the oxygenation of a body of water comprising:
lessening a thermal stratification within the body of water by moving at least some of the water at a second range of depths to an upper range of depths using a centrifugal RFWSS comprising a driving part which includes a driving source, a rotatable shaft coupled to water moving paddles; and, transmitting an alternating signal having an alternating magnetic flux to the water to increase a gas exchange rate, whereby the increase in gas exchange rate is greater than an increase in gas exchange rate from transmitting the alternating signal alone plus an increase in gas exchange rate using the RFWSS alone.

In accordance with an aspect of the disclosure there is provided a system comprising:
a) a flotation structure adapted to at least partially float on water;
b) a mechanical water moving device supported by the flotation structure; and,
c) an electronic device within a working proximity to the mechanical water moving device for increasing oxygenation of a body of water with an electronic signal, wherein a portion of the mechanical water moving device and a portion of the electronic device are lowered into the water when the system is in operation and wherein the use of the mechanical water moving device lessens thermal stratification and thereby enhances the capability of the electronic device.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a cross-sectional view of a prior art transducer.

FIG. 2 is a cross-sectional view of a prior art transducer.

FIG. 3 is a cross sectional view of the prior art transducer illustrating lines of magnetic flux exterior to the coil when the transducer is powered.

FIG. 4 is a cross-sectional view of the prior art transducer.

FIG. 5 is an illustration of a prior art system for changing a property of a polar liquid with a magnetic field.

FIG. 6 is an illustration of a prior art multi-transducer system.

FIG. 7 an illustration of a prior art RFWSS

FIG. 8 is an illustration of an RFWSS with solar panels

FIGS. 9 and 10 are illustrations of the RFWSS of FIG. 7 configured with solar panels

FIG. 11 is a plan view of a RFWSS tethered to a device for electronically changing the gas absorption rate of water in accordance with this disclosure.

FIG. 12 is an illustration of the unitary RFWSS and electronic device for changing the gas absorption rate of water in accordance with this disclosure.

### DETAILED DESCRIPTION

Severe limitations of conventional water moving devices heretofore known as biofans or water cultivating devices are overcome by using together an AMFGD with a RFWSS.

It has been described in U.S. Pat. Nos. 10,934,186, 10,875,794, 10,737,796 and 10,767,021 all in the name of Parisien et al., that by energizing an electrically insulated conductive coil formed of loops of wire in the form of a transducer, and with a very small amount of alternating current of under one ampere, and preferably hundreds of microamps or less, and by placing the energized coil into a polar liquid such as water, one can generate an alternating magnetic field emanating from the coil through the insulation that will affect the polar liquid exposed to the magnetic field by changing a property of the polar liquid, such as gas exchange rate or other properties, and that the affected liquid will in turn have an effect on polar liquid a great distance away, of at least 10 s of meters, through a contagion or domino effect. The benefits of adjusting the gas transfer rate or other properties are numerous and have applicability to many industrial applications and more particularly in increasing the amount of dissolved oxygen within an ocean, lake, pond or lagoon. Advantageously, the loop or coil transducer is insensitive to the conductivity of the polar liquid, and therefore insensitive to the pH of the liquid, thus allowing it to be used in many different liquids irrespective of conductivity or the electrical grounding environment in the vicinity of the treatment vessel.

The magnetic field may be created by a coil within a transducer, while the electric field produced by the transducer is ideally zero.

It I has been discovered that using only an alternating magnetic field, and enhancing its effect by shaping the magnetic field, one is able to change properties of a polar liquid at a distance of 40 meters and more with a very low power signal producing a low intensity alternating magnetic field. It is believed that, when a properly energized transducer, with a suitable electrical signal having a suitable frequency and amplitude, is placed in a polar liquid, the resulting alternating magnetic field emanating from the coil affects the liquid in close proximity to the coil, changing the liquid's property near the coil. Surprisingly, the effect then expands through the liquid, often in a matter of minutes. The difference should be noted between the speed of the field propagation, i.e. the speed of light in the particular medium, and the speed of the liquid-changing effect which is significantly less than the speed of light. The discovered effect may be envisioned as a domino effect in molecules of the liquid: the magnetic field generated by the transducer affects molecules and/or intermolecular bonds in the liquid proximate to the transducer. When a signal of suitable frequency and amplitude is used, the affected portion of the liquid affects another portion of molecules at some distance from the transducer, and so on. The term “domino effect” refers to a linked sequence of events, while the events are not necessarily mechanical as in case of domino tiles. The effect may be referred to as a chain reaction or a contagion effect.

When a coil is immersed in a polar liquid and energized with an alternating electrical current, the frequency of the current and thus the rate of change for the magnetic field affects the distance where a particular property of the liquid noticeably changes. In other words, some frequencies are better than others. The same has been observed for the amplitudes of the current supplied to the coil. This may be explained by resonance effects occurring within polar molecules of the liquid and/or in intermolecular bonds under the influence of the magnetic field produced by the coil. It is important that the optimal (preferred) parameters of the current in the coil depend on the application wherein the coil is used. In particular, the optimal parameters may depend on the particular liquid and the monitored property. Nevertheless, it is crucial that the transducer including the coil affects the liquid with only magnetic field with a practically absent electric field external to the coil; thus the parameters of the current are tuned so as to increase the effects caused by the magnetic field.

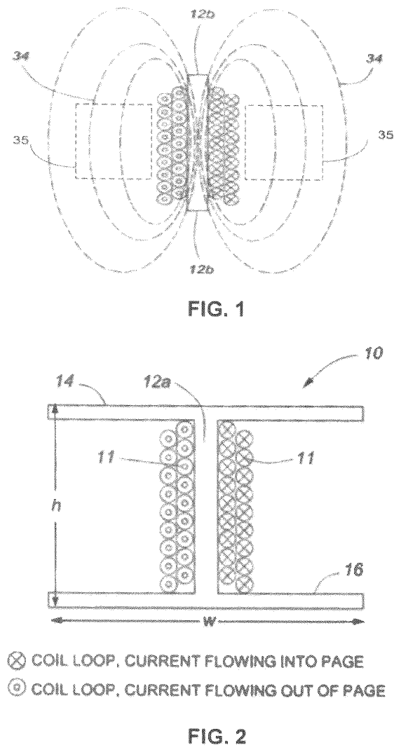

FIG. 1 illustrates a magnetic field provided by a solenoidal (cylindrical) coil wound around a straight support 12b. Field lines 34 proximate to the solenoid are substantially parallel to each other and have same polarity. This portion 35 of substantially unidirectional (at a particular moment) magnetic field may provide a cumulative effect which changes a particular property of the polar liquid about where the coil is immersed. It is preferred that coil is a solenoidal coil, since the cylindrical elongate shape of the solenoid provides the magnetic field around the solenoid, the field almost parallel to the longitudinal axis of the solenoid in close proximity to the coil. The ends of the solenoid potentially have a deleterious effect since the polarities of the converging lines of magnetic flux oppose each other, so it is desirable to reduce or possibly exclude that effect. It is desirable to expand the space around the coil where the magnetic lines are close to being parallel to each other, so that more liquid may experience the cumulative effect of the magnetic field. This can be done by using a very long solenoidal coil, or by shaping the magnetic field with the help of preferably planar end pieces at the ends of the coil.

Additionally, field lines within the support 12b have a different polarity. Thus, if the liquid has access to the interior of the coil, the cumulative effect will be negated. Accordingly, it is desirable to prevent the liquid from being affected by the opposite direction of the magnetic field. This may be achieved by preventing the liquid from entering the interior of the coil, e.g., placing a ferromagnetic core or any kind of support or fill within the interior of the coil, or by placing the coil within a container that prevents liquid from entering the interior region of the coil or the polar regions; however the magnetic field must be able to pass through the container. A ferromagnetic core has the effect of increasing the magnetic flux density as well as preventing the fluid from entering the interior of the coil. Any non-ferromagnetic body placed in the interior of the coil preferably extends beyond the ends of the coil so as to prevent access of the liquid to the most concentrated opposing polarities at the magnetic poles.

Experiments have been conducted where a transducer was designed so as to increase the effect of a unidirectional portion of the magnetic field, while preventing another portion of the field, of the opposite polarity, from penetrating the liquid, at each particular moment. The unidirectional portion 35 of the magnetic field is understood as a spatial volume containing a portion of the magnetic field produced by the coil, wherein field lines within the volume are substantially parallel to each other at a particular moment, while may have the opposite direction at another moment.

The method of changing a property of a polar liquid includes the following steps: (A) disposing a first device adjacent to the polar liquid or at least partially immersed therein, the device comprising a signal generator and a transducer electrically coupled thereto, and (B) operating the signal generator to provide an alternating electrical signal to the transducer, wherein the alternating electrical signal is of a frequency and an amplitude to cause the transducer to produce a resulting alternating magnetic field having a magnetic flux density so as to change the property of the polar liquid, wherein a portion of the alternating magnetic field penetrates the polar liquid, having an effect on the polar liquid and providing a change in the property of the polar liquid at a distance of at least 1 meter from the transducer, wherein the property is gas exchange rate and the change is at least 5% and up to 500% or more. The gas exchange rate relates to transfer of gases across a surface of the liquid, wherein the surface may be the liquid-air interface or a surface of a gas bubble in the liquid, etc. In some embodiments, the surface tension of the liquid may change by at least 1%, or the viscosity of the liquid may change by at least 0.5%, or the freezing point may change by at least 0.5 degree C., or the partial vapor pressure may change by at least 1%. It is believed that the effect produced by the magnetic field is the domino effect discussed above. Preferably, the transducer produces no electric field outside thereof greater than 1 V/m. Even a very small electric field that may be produced by the coil is unwanted. FIG. 8 illustrates a flow chart of the method, wherein the method steps 810 and 820 may be performed in any order, including concurrent execution.

The advantages of the method have been demonstrated for such properties as gas exchange rate.

The time necessary for the change to become detectable depends on the distance from the transducer. This suitably programmed signal generator and transducer are the core elements of the AMFGD.

It should be understood that the method disclosed is practicable by simply using a coil having a plurality of turns without having a core 12a, when the interior of the coil is empty but inaccessible to the liquid, e.g., sealed. In another embodiment, a magnetically permeable core is provided. Alternatively, the core can be a plastic spool for example used to form the many turns of wire resulting in the coil. The spool may be another material, which does not deleteriously affect the transducer's performance, or there may be no spool or core present and the liquid may be prevented from entering the interior of the coil by other means.

FIGS. 2 through 5 illustrate transducers whereby a property such as an interfacial mass transfer rate or other properties of a polar liquid can be changed if the transducer is provided with an alternating signal e.g., of about 2.5 kHz and having a current of about 133 microamperes. Of course, the method is not limited to this frequency or current, as these are just exemplary embodiments that provided surprisingly favorable results. It is suggested that frequencies between 100 Hz and 20 kHz will produce a change in a property of a polar liquid, with a preferable interval of frequencies between 1 kHz and 5 kHz.

FIG. 2 illustrates an exemplary embodiment. A transducer 10 has a solenoidal coil 11 of electrically insulated wire wrapped around the core 12a. Here and elsewhere in the drawings, a circle with a cross indicates a cross section of a coil loop wherein a current flows into the plane of the drawing, while a double circle indicates a cross section of a coil loop wherein the current flows out of the plane of the drawing. The insulation of the wire allows a magnetic field to pass therethrough. The two ends of the coil are electrically coupled to two terminals of a signal generator (not shown), so that the alternating current can flow through the coil 11 from the signal generator and back to the signal generator. In operation an alternating electrical current in the form of a 2.5 KHz sine wave is provided to the coil 11. The root mean square (rms) of the alternating current amplitude is 133 micro amps. As is well understood, a magnetic field is generated emanating from and external to the coil 11. The transducer 10 has a core 12a made of a ferromagnetic material, for example, mild steel or stainless steel. Integral with the core are planar end pieces 14 and 16, also made of mild steel or stainless steel or other alloys, with the relative permeability of from 100 to 5000 and possibly more. The height of the coil 11 and the core 12a is h=3.5 cm, and the diameter (max dimension) of the end pieces is W=5 cm.

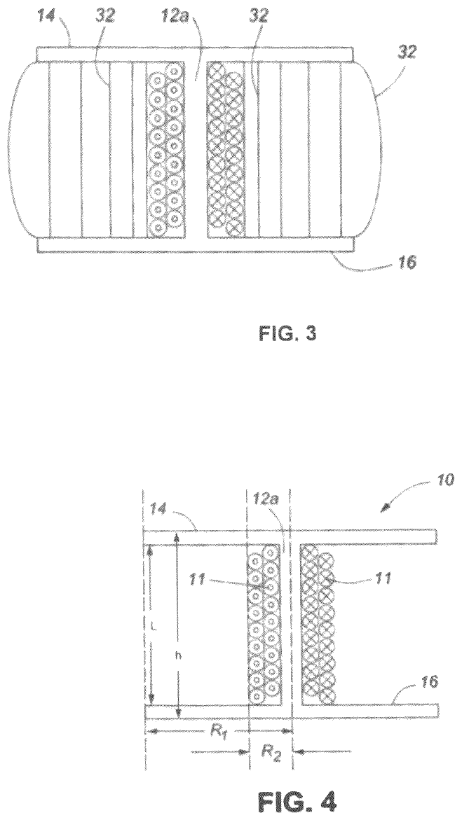

FIG. 3 illustrates the magnetic lines of flux 32, which are substantially parallel due to the elongate, substantially straight shape of the core and due to the field-shaping effect of the end pieces 14 and 16 extending normally to the core. Unconstrained, the core 12b absent the polar end pieces, the magnetic lines of flux 34 are not parallel as is shown in FIG. 1. To achieve a greater effect on the liquid that the transducer is placed in, it is preferred to have substantially parallel lines of flux. The end caps 14 and 16, on the poles of the core 12a of the transducer 10 (FIGS. 2 and 3) concentrate the magnetic lines of flux 32 so that the lines of flux external to the coil 11 and core 12a are almost parallel.

Turning now to FIG. 4, the transducer 10 is shown to have a height h and radius R1. Radius R2 defines the radius from the center of the metal core 12a to the outside of the coil 11 having N turns. By way of example, the height of the coil L=3 cm, h=3.5 cm, R₁=2.5 cm, R₂=0.8 cm, N=44 turns of 22-gauge single strand insulated wire. The core was made of mild steel.

Experiments have been made so as to observe the impact of exposure of water to magnetic fields as described herein, on mass transfer rate across the air water interface of bubbles.

Using the AMFGD with the RFWSS together increases gas flux across the air-water interface through changes in physicochemical properties. These changes increase the transfer of oxygen into the upper surface layer of the water body. The RFWSS, then, moves and spreads the oxygen-enriched water, bringing less oxygenated water to the surface This ensures that flux is always from the air which is a body of high oxygen into the surface water having lower oxygen since the surface is not oxygen-saturated. Thus, there is an effect on methane in two ways. First, by increasing the depth profile of the oxygen-rich zone, the water body can support a greater population of methane consumers, Second, since the use of the AMFGD and RFWSS is gas-agnostic, it affects the mass-transfer rate of methane gas from bubbles that are rising in the water column. Therefore, as methane bubbles rise, methane moves out of the bubble via the changes in physicochemical properties and the bubbles have a longer residence time in an oxygen-enriched zone populated with methanotrophs the depth of the oxygen right zone has been increased.

Several frequency and current pairs have been found to provide better results than others: 2500 Hz at the current of 0.100 mA, 2700 Hz at the current of 0.099 mA, and 4000 Hz at the current of 0.140 mA. The search for preferable parameters was based on theoretical hypotheses of how the technology worked and included adjusting parameters while the effect has been measured. More such parameters may be found by experimentation. It is expected that the advantageous effect may be achieved for frequency and current deviating from the particular preferable parameters by +10 Hz and +15 micro Amperes, respectively. The inventors stated that other frequency and current pairs which result in changing a property of a polar liquid at a distance of at least 10 meters may be found. It should be appreciated that the parameters of the magnetic field and the required electrical signal may vary depending on the liquid, e.g., the level and nature of contamination in water. The geometry of the vessel or water body may also affect the parameters needed to achieve the desired effect. For the embodiment shown in FIGS. 2 through 4, it has been demonstrated that preventing a portion of the magnetic field interior to the coil 11 from contacting the fluid, the other portion of the magnetic field, the portion exterior to the coil 11, is able to noticeably and effectively change a property of the liquid it is submerged in. Thus either blocking the inside magnetic field or preventing the liquid from accessing the magnetic field within the interior of the coil allows the field exterior to the coil 11 to significantly change a property of the liquid. The suggested transducer design ensures that magnetic fields in these different regions do not simultaneously pass through the polar liquid or they would have a deleterious effect on each other not producing a desired change in a property of the polar liquid. Preferably the magnetic field interior to the coil of FIG. 2 is totally or substantially prevented from propagating through the liquid, in a less preferred embodiment at least 75% of the magnetic field interior to the coil 11 is prevented from penetrating the polar liquid. Relative to the portion of the magnetic field exterior to the coil, it is desirable that at least 75% of the magnetic field exterior to the coil and emanating from the coil, penetrate the liquid.

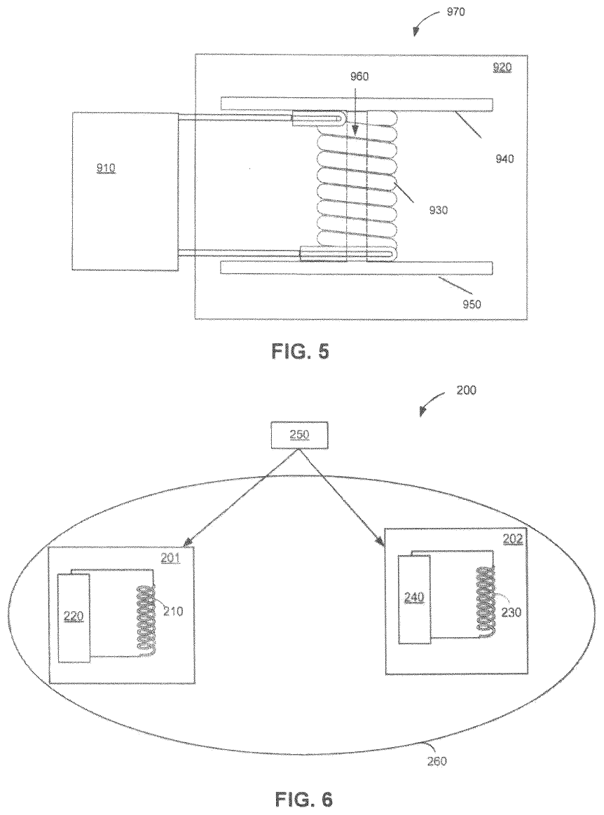

The aforedescribed transducers may be used in a system for changing a property of a polar liquid with a magnetic field. With reference to FIG. 5, the system includes a signal generator 910 for generating an alternating electrical signal, and at least one transducer 920, which has an electrically conductive coil 930 with an insulation which electrically insulates one loop of the coil from one another, though allows a magnetic field to pass through. No electrical current is imparted from the device to the polar fluid.

The coil 930 is coupled to the signal generator 910, so that the generator 910 can provide an alternating electrical current to the coil 930, and so providing magnetic field about the coil 930.

Preferably, the coil 930 is a solenoidal coil, i.e., a cylinder in the sense that it has a straight central axis and all cross sections normal to the axis have a same shape, though not necessarily a circle. By way of example, the core 12a (FIG. 3) may be a steel bar with a square cross-section. The wire wound around such a core forms a cylinder wherein a cross section resembles a square with rounded corners. The height of the cylinder is preferably in the range of from 3 cm to 50 cm.

The coil is formed of loops of a conductive metal, such as copper, etc. The number of loops may be in the range of from 20 to 2000. The loops are electrically isolated. Each loop has an empty interior which may be filled e.g., with a support or core around which the loops are coiled. The stack of loop interiors forms an interior 960 of the coil 930. The coil interior 960 is protected from the liquid when the transducer is immersed therein so that a portion of the magnetic field internal to the coil 930 is substantially prevented from penetrating the liquid. The interior 960 of the coil 930 may be filled with some material as discussed elsewhere herein, or sealed. While FIG. 5 shows the coil 930 as having a single layer of wire, the coil 930 may be formed of one, two, or more layers of wire, a next layer looped around a previous layer. FIG. 2 illustrates an embodiment of the transducer described with reference to FIG. 5, wherein the coil 11 has two layers of wire.

The transducer 920 has two end pieces 940 and 950 for shaping a portion of the magnetic field external to the coil 930 thereby causing it to penetrate the liquid. The end pieces 940 and 950 are disposed at the ends of the coil 930 transverse thereto, preferably normally, so that the force lines of the magnetic field between the end pieces are substantially parallel to the central axis of the coil 930. The end pieces 940 and 950 are electrically isolated from the coil. Each of the end pieces 940 and 950 is made of a magnetically permeable material with relative permeability of at least 100 times higher than relative permeability of the polar liquid under the treatment, preferably of a ferromagnetic material such as mild steel or stainless steel or other alloys, with the relative permeability of from 100 to 5000 and possibly more. The end pieces 940 and 950 may be planar and normal to the coil. They may be round and centered at the coil. The diameters (max measurement) of the end pieces are preferably at least half of the height of the coil which, in turn, may be 3 cm≤L≤50 cm. In one embodiment, the end pieces have a radius of at least the outer radius of the solenoidal coil plus the radius of the core. In one embodiment the end pieces are two cones with their apexes directed away from each other and their axis of symmetry coinciding with the central axis of the solenoid.

Accordingly, a system for providing an alternating magnetic field to a polar liquid for changing a property thereof, or for changing a biological response from biological material within the polar liquid, comprises a first device comprising: a first signal generator for generating a first alternating electrical current; and, a first transducer for at least partially immersing into the polar liquid, comprising: an electrically conductive solenoidal coil for coupling to the first signal generator for providing the alternating magnetic field in response to the first alternating electrical current, the electrically conductive solenoidal coil formed of a plurality of loops each having an interior, the loop interiors forming an interior of the electrically conductive solenoidal coil, wherein the polar liquid is prevented from penetrating the interior of the electrically conductive solenoidal coil when the first transducer is immersed in the polar liquid, and two ferromagnetic end pieces, one at each end of the electrically conductive solenoidal coil transverse thereto and electrically isolated therefrom, for shaping a portion of the alternating magnetic field external to the electrically conductive solenoidal coil and penetrating the polar liquid when the system is immersed in the polar liquid and operational. The system comprises a ferromagnetic core within the interior of the electrically conductive solenoidal coil, electrically isolated therefrom. The two ferromagnetic end pieces are magnetically coupled to the ferromagnetic core or integral therewith, wherein each of the two ferromagnetic end pieces has a surface portion facing another of the two ferromagnetic end pieces, the surface portions are disposed farther from one another at the electrically conductive solenoidal coil and closer to one another away from the electrically conductive solenoidal coil for shaping the portion of the alternating magnetic field external to the electrically conductive solenoidal coil.

The interior 960 of the coil 930 may be filled with any material so as to ensure that the liquid is substantially prevented from entering the interior of the coil and, thus, is not affected by a portion of the magnetic field within the interior of the coil. Ideally 100% of liquid is prevented from entering the interior of the coil. Less preferably, 80% and less preferably 50% is prevented. Liquid entering the coil has a deleterious effect. In one embodiment, the interior 960 of the coil is filled with one or more non-ferromagnetic materials, i.e., materials with relative magnetic permeability less than or equal to 1 H/m.

The signal generator 910 may be configured for providing a periodic electrical current with a predetermined amplitude and frequency. The current is preferably less than 3 amperes, more preferably less than 500 mA, and more preferably less than 50 mA. A feedback loop may be used to control the electrical signal in dependence upon a measured parameter. The signal generator 910 may be capable of providing a plurality of predetermined frequencies or a predefined range of frequencies, and the system may utilize a frequency determined to be optimum from the plurality of frequencies. A measuring instrument capable of measuring a parameter, such as a value of gas exchange rate, surface tension, viscosity, freezing point temperature, or partial vapor pressure, can be connected to a feedback circuit that can be used to adjust the frequency and amplitude of the signal provided to the transducer to optimize or enhance a process that requires a change in property of the polar liquid.

In particular, the signal generator 910 may be configured to work in at least one of the following modes experimentally found to provide advantageous results: 2500 Hz at the current of 0.100 mA, 2700 Hz at the current of 0.099 mA, and 4000 Hz at the current of 0.140 mA. It is expected that almost the advantageous effect may be achieved for frequency and current deviating from the particular optimal parameters by +/−10 Hz and +/−15 uA, respectively, while the effect may be reduced to about 63% of the peak effectiveness.

The transducer 920 and the signal generator 910 may be part of a PCD 970 intended to be at least partially immersed in an industrial pond, river, ocean, etc. Preferably, the signal generator and the transducer are housed separately and connected by a pair of wires or a coaxial cable. In one embodiment, the coil is at least partially immersed in the liquid, while the signal generator is not immersed-it may reside on a raft whereto the coil is attached. In another embodiment, the signal generator is at least partially immersed in the liquid. Then the interior of the device 970 provides an electrically isolated space in which to house the electronics required to operate the device. In one embodiment, the device includes floating means, such as foam flotation ballast. In one embodiment flotation is provided by trapping air or foam in the sealed container wherein the electronics are kept. Foam helps to avoid the diurnal expansion and contraction of the air with the accompanying condensation of moisture inside the electronic housing. A metallic strip through the foam may be used to permit the transmission of heat generated by the electronic circuit. The device 970 may have an antenna for wireless communication with a control center or other transducers, and/or a GPS receiver.

In one embodiment, a relatively long solenoidal coil is partially immersed in a liquid transverse thereto, so that the top end of the coil and associated curvature of the magnetic field are above the surface and practically do not affect the liquid, while the lower end of the coil and associated curvature of the magnetic field are relatively far below from the surface, thus having little effect on the near-surface layer of the liquid. Then, at each particular moment, the near-surface layer of the liquid Is affected by substantially parallel field which changes the liquid's property. The coil may have a core, and may have the interior of the coil sealed at both ends or only at the bottom end leaving the upper end open to the air. The transducer may be supported by a floating means, e.g., a buoy, or be attached to a wall of the vessel or body of water, etc. As in other embodiments, the liquid is prevented from entering the interior of the coil.

In one embodiment, the PCD may be moved across a body of water or other liquid, with the help of a boat, vessel or craft, preferably in a controlled manner, or supported by a buoy or raft. In this embodiment, a waterproof buoyant container houses the battery, and signal generator which is coupled to the transducer. A solar panel is housed on top of the waterproof buoyant container, and is electrically coupled to the battery. The PCD is relatively lightweight and can easily be carried by a person and placed into the water. Housed within the container is a transceiver and control circuitry so that it can be powered and switched off remotely.

The disclosure provides a method of treating a body of water, wastewater, sewage or sludge having a surface area of at least 100 square feet to increase the amount of dissolved oxygen therein, comprising: at a first location within the body of water, waste water, sewage, or sludge, providing a portable, buoyant device having a signal generator housed therein; and having a submersible transducer electrically coupled to the signal generator; and, operating the signal generator to provide a low power alternating electrical signal of less than five hundred watts and preferably less than one watt to the submersible transducer, wherein the submersible transducer in response to the low power alternating electrical signal produces an alternating magnetic field, wherein the alternating electrical signal is of a frequency and intensity to affect the transducer to produce a resulting alternating magnetic flux density so as to cause neighboring or nearby water molecules influenced by the alternating magnetic flux to influence other more distant water molecules causing a chain reaction throughout a 100 square foot region wherein the effect of applying the alternating magnetic flux density to nearby water molecules increases a gas exchange rate and dissolved oxygen flux rate throughout the 100 square foot region by at least 5% within 24 hours of applying the signal.

In another aspect there is provided, a method of treating a body of water, wastewater, sewage or sludge having a surface area and being at least 15 feet in length, to increase the amount of dissolved oxygen therein, comprising: at a first location within the body of water, wastewater, sewage or sludge, providing a portable, buoyant unit having a source of power coupled to a signal generator housed therein and having a submersible transducer coupled to the signal generator; actuating the signal generator to provide a low power alternating electrical signal having a first frequency and a power of less than 5 watts and preferably orders of magnitude less to the transducer, wherein the transducer is designed to produce an alternating magnetic field which emanates into the water, wastewater, sewage or sludge when placed therein in response to the low power alternating electrical signal, wherein the first frequency and power of the alternating electrical signal produces a resulting magnetic flux in the water, wastewater, sewage or sludge which causes water molecules adjacent to the transducer influenced by the alternating magnetic flux to influence other more distant water molecules causing a chain reaction at least 15 feet from the transducer, wherein alternating frequency and magnetic flux density is such as to cause a gas exchange rate increase and dissolved oxygen flux rate by at least 2 times from baseline at least 15 feet from the first location within 24 hours of applying the signal.

Preferably, the coil 11 is a solenoidal coil, i.e., a cylinder in the sense that it has a straight central axis and all cross sections normal to the axis have a same shape, though not necessarily a circle. The cylindrical elongate shape of the solenoid ensures that the field lines of the magnetic field in the interior of the solenoid is substantially parallel to the longitudinal axis of the solenoid. The height of the coil may be in the range of from 3 cm to 50 cm. The number of loops may be in the range of from 20 to 2000. Each loop has an interior, and a stack of loop interiors forms an interior of the coil 11. The outer regions of the coil 11, and preferably the ends of the solenoid as well, are covered with a cladding, also referred to as a container or a cover.

The cladding serves the purpose of preventing a portion of the alternating magnetic field external to the electrically conductive solenoidal coil from penetrating the polar liquid when the system is immersed in the polar liquid and operational. The cladding may be formed of a ferromagnetic material, possibly of mild steel or stainless steel or other alloys, with the relative permeability of from 100 to 5000 and possibly more. Other materials may be used for the cladding, which will guide the outer field from the liquid and into the material. The cladding may be formed on the outer surface of the solenoid or adjacent thereto. In one embodiment, the cladding is substantially a cylinder around the solenoidal coil.

The end portions of the cladding, at the ends of the solenoidal coil, are transverse to the cylinder walls of the cladding.

In one embodiment, the signal generator is mounted on a moving raft, which also moves the submerged transducer. The transducer also includes a signal generator, not shown, for generating an alternating electrical current and providing it to the coil 11. Thus, one aspect of the disclosure provides a system for providing an alternating magnetic field to a polar liquid for changing a property thereof, or for changing a biological response from biological material within the polar liquid. The AMFGD system comprises a property-changing device (PCD) comprising: a signal generator for generating an alternating electrical current; and, a transducer for immersing into the polar liquid, comprising: an electrically conductive solenoidal coil for coupling to the signal generator for providing the alternating magnetic field in response to the alternating electrical current, the electrically conductive solenoidal coil formed of a plurality of loops each having an interior, the loop interiors forming an interior of the electrically conductive solenoidal coil, wherein the interior of the electrically conductive solenoidal coil has a channel for the polar liquid to pass through when the transducer is immersed in the polar liquid, and a ferromagnetic cladding around the electrically conductive solenoidal coil and electrically isolated therefrom, for preventing a portion of the alternating magnetic field external to the electrically conductive solenoidal coil from penetrating the polar liquid when the transducer is immersed in the polar liquid and operational.

The aforedescribed transducers together with signal generators such as the generator 910 shown in FIG. 5 may be used in property-changing devices (PCD) for performing the method disclosed herein, comprising: disposing a first transducer at a first location, adjacent to or at least partially immersed in the liquid, and operating the signal generator to provide an alternating electrical signal to the transducer, wherein the alternating electrical signal is of a frequency and an amplitude to cause the transducer to produce a resulting alternating magnetic field having a magnetic flux density so as to change the property of the polar liquid, wherein a portion of the alternating magnetic field penetrates the polar liquid, having an effect on the polar liquid and providing a change in the property of the polar liquid at a distance of at least 1 meter from the transducer, wherein the property is gas exchange rate and the change is at least 5% (step 820). Alternatively, other properties of the polar liquid at that location may change as well: the surface tension may change by at least 1%, or the viscosity may change by at least 0.5%, or the freezing point may change by at least 0.5 degree C., or the partial vapor pressure may change by at least 1%. In order to employ a substantially unidirectional portion of the magnetic field, in one embodiment the liquid from outside of the transducer is substantially prevented from penetrating the interior of the coil when the transducer is immersed in the liquid, and in another embodiment a portion of the alternating magnetic field external to the electrically conductive solenoidal coil is substantially prevented from penetrating the polar liquid when the transducer is immersed in the polar liquid.

With reference to FIG. 6, the aforedescribed transducers may be used in a multi-transducer system which includes at least two transducers 210 and 230 and a control center 250. Each of the transducers includes a coil for generating magnetic field when provided with an alternating electrical current. Preferably, the transducers are cylindrical coils and include end pieces as described above. However, other transducers may be used under control of the control center 250. Preferably, each of the transducers is electrically connected to its own signal generator. As shown in FIG. 6, a first signal generator 220 provides an alternating electrical current to the first transducer 210, and a second signal generator 240-to the second transducer 230. In another embodiment, one signal generator provides an electrical current to two or more transducers.

Turning back to FIG. 6, the transducers may be placed in a vessel or an open body of water or sludge, etc., 260. By way of example, immersive devices 201 and 202, each incorporating a transducer and preferably a signal generator, may be placed at a distance D (20 cm≤D≤300 m) from one another at least partially immersed in an industrial pond, river, lake or ocean. The control center 250 may be located ashore or elsewhere and communicate with the devices 201 and 202 over any communication protocol, preferably wirelessly. In one embodiment, multiple transducers may be deployed without a controller. The transducers may run independently of each other, or coordinate with each other via a peer-to-peer protocol.

Placing two same transducers, for example, two coil transducers, within a polar liquid or body of water, different effects can be obtained depending upon how the two transducers are operated. This provides a convenient way, in which a desired property of the polar liquid may be controlled, such as viscosity, surface tension, equilibrium partial pressure in the gas phase, and freezing or boiling point of the polar liquid.

Two or more transducers may be used together and controlled from a same control center, wherein frequencies of the electrical current in the transducers are same and the first and second alternating electrical currents are in phase, having a zero-degree phase relationship for increasing the change in the polar liquid. We have discovered that by using two transducers 10 provided with a same frequency alternating signal and wherein the signals are in phase, interfacial mass transfer rate was increased further than the increase provided by a single transducer. By way of example, a 16% increase in interfacial mass transfer rate provided by a single transducer was further increased to 20% when a second transducer having the same frequency and in phase was introduced; the transducers should be spaced apart a suitable distance to maximize a desired effect. For example, a plurality of transducers can be spaced along a water body such as a channel in order to change the freezing temperature of the water in the regions of the channel about which the transducers are placed. Adjusting the phase between the two signals provided to two transducers so that the two signals were out of phase, that is, offset or skewed in phase by varying amounts attenuated the desired effect. The property change lessened down to close to or about zero, in this instance the transducers having little or no effect. Notwithstanding, since skewing the phase attenuated the desired effect, tuning in manner by adjusting the phase by small offsets (gradually) is a way in which control of the desired effect can be achieved. For example, a 20% increase in interfacial mass transfer rate achieved with two transducers having signals in phase, could be lessened for example to 10% by skewing the phase accordingly.

Furthermore, two or more transducers may be used together and controlled from a same control center, wherein frequencies of the electrical current in the transducers differ from one another, for changing the property of the polar liquid oppositely to the change caused by one transducer alone. The opposite changes are understood as opposite with respect to a baseline of the property when the liquid has not been treated by a magnetic field. The baseline is the natural state of the liquid before the transducer(s) are turned on and affect the liquid in any manner. By way of example, one transducer may increase a particular parameter measuring a property of the liquid above the baseline characterizing the untreated liquid, while two transducers with offset frequencies will decrease the same parameter below the baseline.

A difference in frequency between two transducers by even 1 Hz changed the effect on the polar liquid, decreasing interfacial mass transfer rate below that of untreated polar liquid rather than increasing interfacial mass transfer rate. Interfacial mass transfer rate is one of many properties that can be changed. The same effect was found with a 5 Hz offset in frequency. If the phase is offset gradually, the effect is attenuated more and more all the way down to zero. This is important as it allows one to control the intensity of the effect.

Advantageously, the system disclosed herein can be placed within any liquid that will accommodate it. It can be scaled up, or down in size as required. Different industrial applications may dictate different depth of placement of our device. In most open water bodies the remediation effort is driven by the oxygen transfer on the surface of the water body. Placing one or more transducers near the water surface with a floating device to accommodate a fluctuating water level is the preferred embodiment. In contrast prior art systems which require being external to a pipe or conduit in which water flows, requires a pipe that will allow a magnetic field to penetrate and flow through without significantly affecting the field. Furthermore, such systems cannot easily be moved from one location to another. Once fixed to a pipe it typically remains in place.

The transducer described heretofore or a plurality of such transducers, spaced apart and in various modes of operation, may be used for altering water conditions in a water body by increasing levels of dissolved oxygen and increasing oxidation-reduction potential (ORP) in the presence of a low intensity magnetic field to favor the growth of aerobic bacteria and added diatoms as a means of suppressing residual ammonia concentration and the growth of cyanobacteria and the like.

The overabundance of cyanobacteria in stagnant waters, as a result of the eutrophication of water, is a worldwide problem, especially because of the fact that vegetative secretions of cyanobacteria can be toxic.

Currently, cyanobacteria in stagnant waters of lakes and dams are disposed of by means of biomechanical equipment using float structures, built on the principles of biological reduction of phosphorus and nitrogen in water by cultivating special aquatic plants. The disadvantages of these devices are low efficiency, requirement of taking care of plant growth and limitations due to the vegetation period of plants.

Accordingly, the method and system of this disclosure provides a viable, cost-effective system and method for significantly reducing the presence of residual ammonia, and cyanobacteria commonly known as blue-green algae, from large bodies of water where it is present.

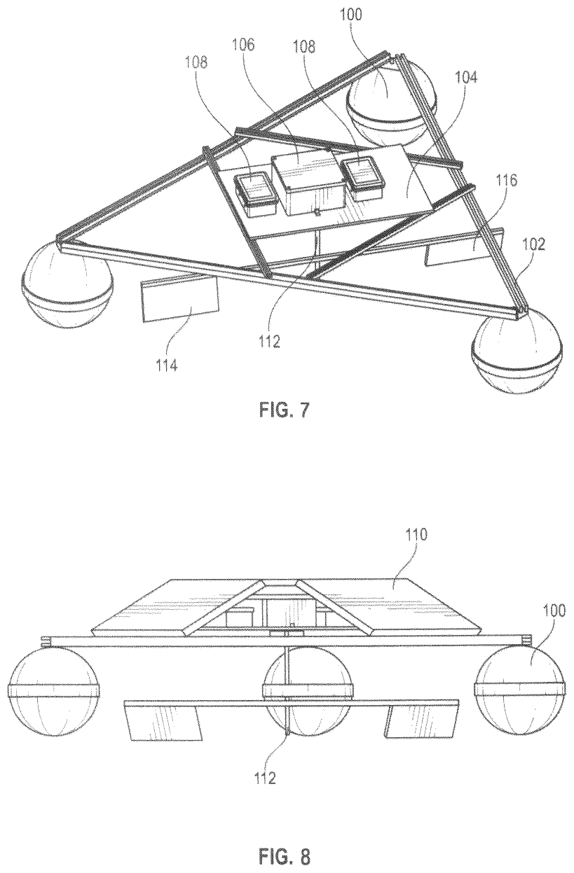

Turning now to FIG. 7, a mechanical water moving device in the form of a RFWSS 99 is shown having three flotation spheres 100 supporting an aluminium corrosion resistant frame, 102 which supports a platform 104 housing a motor 106, a battery pack 108 and solar panels 110. A shaft 112 coupled to the motor is shown having paddles 114 and 116 attached thereto. The paddles 114, 116 rotate with the shaft sweeping through 360 degrees within the water. The distance between each of the flotation spheres depends upon the overall size of the RFWSS device and this dimension can vary. This critical rotation speed will be determined by the size of the rotating blades/paddles of the RFWSS, angles of rotation, local water temperature, water flow rate, wind speed above the waterbody, the topography of the waterbody and proximity to physical barriers (e.g., other mechanical devices, islands, weirs, aquatic plants, etc.). By way of example, an RFWSS having 3 blades of length 1-2 m can have a rotation speed between 5 and 200 revolutions per minute. This critical rotation speed is expected to be below 200 rpm and likely below 50 rpm to achieve a Reynolds Number of the radially outward flowing water below 5,000, and preferably below 1000. Preferably the rotation speed is between 5 and 15 RPMs. In a preferred embodiment the RFWSS and the AMFGD together use less than 100 watts of power.

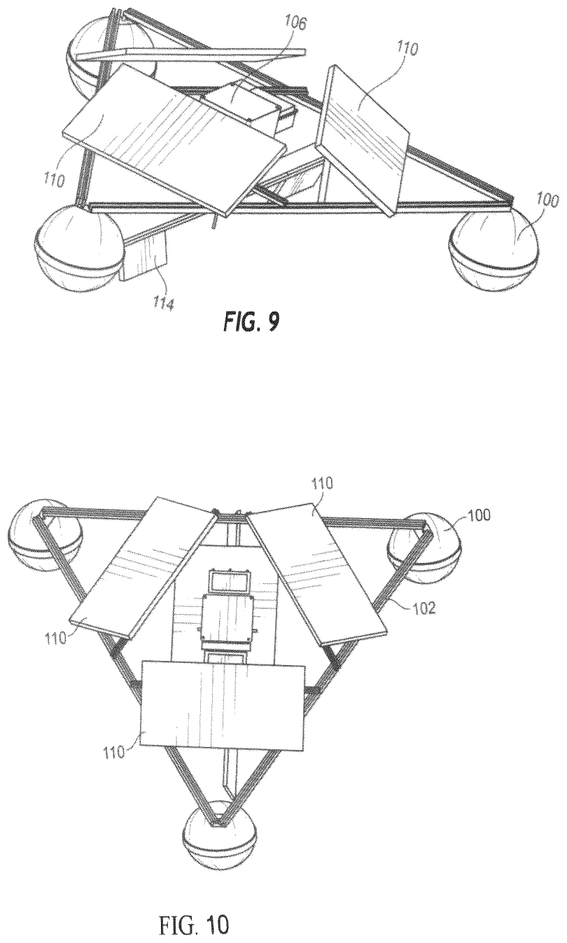

FIGS. 8 through 10 are shown having solar panels installed which power the electric motor of the RFWSS. Deep cycle batteries are provided so that the RFWSS can operate at night.

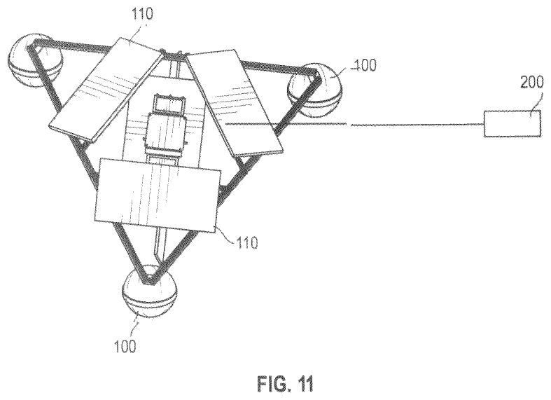

In an embodiment shown in FIG. 11 the RFWSS 99 and the transducer 200 are tethered by a tether together so that one can influence and enhance the performance of the other. It is preferred that the RFWSS be disposed within a distance from the transducer at which the transducer-based device 200 can provide an effective result.

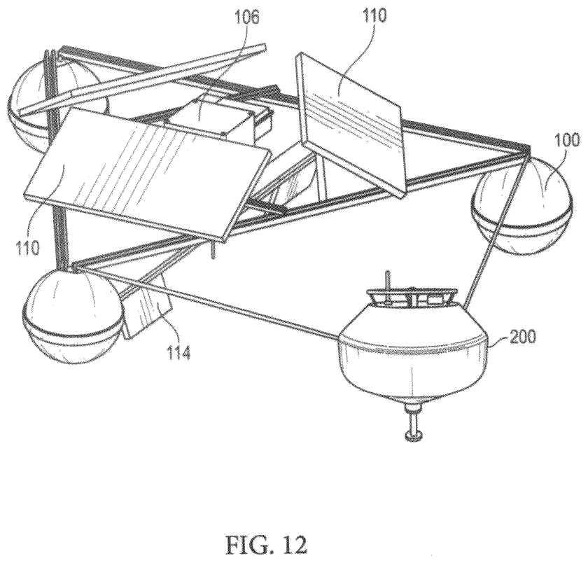

FIG. 12 is a drawing showing the system wherein a RFWSS and electronic device 200 are integrated within a single unit. An advantage of this is that the two devices can operate at the same time powered from the same solar powered battery and the electronic device can operate or mildly churned water as a result of the action of the RFWSS 99. The effective operating range of the RFWSS is approximately 70 meters although not limited thereto and depends on the size of the RFWSS. This range is less than the effective operating range of the electronic device such as the one described heretofore. The property changes in the water columns within the operating range of the RFWSS will cause convective mixing with the adjacent water columns. Consequently, to maximize the acceleration of oxygenation of a large waterbody, placing evenly 4 RFWSSs 100 m from each electronic device will likely be the most cost-effective arrangement. For smaller waterbodies, e.g., those with radius of 100 m or less, the device described is believed to be adequate.

In a preferred embodiment the RFWSS is equipped with an automated steerable electric trolling motor coupled to a GPS tracking system and a suitably programmed microprocessor to control the direction of the RFWSS so that it slowly moves and covers as much of the waterbody as possible over a predetermined amount of time. The GPS tracking program ensures that the RFWSS only traverses a desired region on the water body.

In a less preferred embodiment, the RFWSS can be tethered to an anchored location central the waterbody and an electric motor can be programmed to randomly steer it so that it covers an area about where the tether is.

As has been described within this disclosure, the use of the AMFGD and RFWSS together, provide advantages over the sum of their benefits alone. Numerous aspects of synergy result from their use together. There is a greater gas exchange rate by their use together than the sum of their outputs alone, and less power is required when they are used together as the viscosity and surface tension are lessened, thereby reducing the energy required to turn the paddles of the RFWSS. In addition to this, the otherwise resulting anoxic state of the water at night, is lessened by using the RFWSS with the AMFGD. The low power RFWSS when in operation continually moves the water from lower depths into an upper region where the AMFGD is able to affect this water so that accelerated gas exchange can occur. We know of no other two devices that when used together that can achieve as much gas exchange, i.e. oxygenation of large water bodies as the AMFGD with the RFWSS with as little power consumed.

What is claimed is:

1. A method of accelerating the oxygenation of a body of water and lessening an amount of methane released into the atmosphere comprising:
moving with a radial flow water surface spreader (RFWSS) having a plurality of paddles, at least some of the water at a second range of depths to a first range of depths; and,
transmitting an alternating signal with an electronic device having an energized first transducer to affect at least some of the moved water to change a property thereof, wherein the property is gas exchange rate.

2. A method of accelerating the oxygenation of a body of water and lessening an amount of methane released into the atmosphere as defined in claim 1 wherein the water at the first range of depths is within a first density range and is an upper layer of water and wherein the water at the second range of depths is within a second density range and is a lower layer of water, and wherein a boundary layer between the upper and lower layer is a thermocline or halocline defining a transition zone in temperature or salinity and density wherein the thermocline or halocline has a greater temperature or salinity gradient than the upper or lower layers of water.

3. A method of accelerating the oxygenation of a body of water and lessening an amount of methane released into the atmosphere as defined in claim 2 wherein in operation the plurality of paddles rotate about an axis at less than 200 revolutions per minute (RPMs).

4. A method of accelerating the oxygenation of a body of water and lessening an amount of methane released into the atmosphere as defined in claim 3, wherein the speed at which the paddles rotate provides an outward flowing water having a Reynolds Number of less that 5,000.

5. A method of accelerating the oxygenation of a body of water and lessening an amount of methane released into the atmosphere as defined in claim 4, wherein transmitting the electronic signal includes disposing the first transducer comprising a first electrically conductive solenoidal coil at least partially within the water, the coil formed of a plurality of loops each having an interior, the loop interiors forming an interior of the coil, and applying a first alternating electrical current to the coil so as to produce an alternating magnetic field about the coil, wherein a portion of the alternating magnetic field penetrates the water and the first alternating electrical current has a first frequency and a first amplitude such that the alternating magnetic field has an effect on the water providing a change in the property of the water at a distance of at least 5 meters from the first transducer, wherein the property is a gas exchange rate.

6. A method of accelerating the oxygenation of a body of water and lessening an amount of methane released into the atmosphere as defined in claim 5 wherein the change in the gas exchange rate is greater than 5%.

7. A method of accelerating the oxygenation of a body of water and lessening an amount of methane released into the atmosphere as defined in claim 6 wherein the transducer and the centrifugal RFWSS are within a proximity of each other of less than 500 meters.

8. A method of accelerating the oxygenation of a body of water and lessening an amount of methane released into the atmosphere as defined in claim 6 wherein the property is gas exchange and change of the property is more than 400%.

9. A method of accelerating the oxygenation of a body of water and lessening an amount of methane released into the atmosphere as defined claim 7 wherein the transducer and the centrifugal RFWSS are within a proximity of each other of less than 250 meters.

10. A method of accelerating the oxygenation of a body of water and lessening an amount of methane released into the atmosphere as defined in claim 9 wherein the RFWSS and transducer are tethered together or are affixed to a same object.

11. A method of accelerating the oxygenation of a body of water and lessening an amount of methane released into the atmosphere as defined in claim 10, wherein the centrifugal RFWSS and/or the transducer are powered by one or more solar modules.

12. A method of accelerating the oxygenation of a body of water and lessening an amount of methane released into the atmosphere comprising:
moving at least some of the water at a first range of depths within a first density range with at least some of the water at a second lower range of depths at a second density range using a centrifugal RFWSS comprising a driving part which includes of a driving source, a rotatable shaft coupled to water moving blades; and, transmitting an alternating signal having an alternating magnetic flux to the water to increase a gas exchange rate, whereby the increase in gas exchange rate is greater than an increase in gas exchange rate from transmitting the alternating signal alone plus an increase in gas exchange rate using the centrifugal RFWSS alone.

13. A method of accelerating the oxygenation of a body of water as defined in claim 12 wherein said moving lessens a difference in density between the average density of the first density range and the average density of the second density range.

14. A system for accelerating the oxygenation of a body of water by changing a property of water within the body of water comprising:
a) a first flotation structure adapted to at least partially float on water
b) a RFWSS supported by the first flotation structure for moving some of the water; and,
c) an electronic device for changing a property of water supported by the first or a different flotation structure, wherein a portion of the mechanical water moving device and a portion of the electronic device is lowered into the water when the system is in operation.

15. A system as defined in claim 14 wherein the electronic device includes a transducer device for extending the effective range of the mechanical water moving device by lowering the water viscosity.

16. A system as defined in claim 15 wherein the RFWSS has paddles or blades that rotate about a central axis and wherein the speed of rotation is less than 50 RPMs when the RFWSS is in operation.

17. A system as defined in claim 16 wherein the total power consumed when the system is in operation is less than 400 watts.

18. A system as defined in claim 16, wherein the RFWSS has means coupled to a controller for moving it a distance across a water body.
